(19) United States
(12) Patent Application Publication
(10) Pub. No.: US 2014/0074886 A1
(43) Pub. Date: Mar. 13, 2014

(54) Taxonomy Generator

(71) Applicants: Alyona Medelyan, Auckland (NZ); Jeen Broekstra, Wellington (NZ)

(72) Inventors: Alyona Medelyan, Auckland (NZ); Jeen Broekstra, Wellington (NZ)

(73) Assignee: Pingar Holdings Limited

(21) Appl. No.: 13/612,735

(22) Filed: Sep. 12, 2012

(51) Int. Cl. G06F 17/30

(52) U.S. Cl. CPC G06F 17/30477
USPC 707/777

(57) ABSTRACT

In one aspect there is provided a method. The method may include extracting, from a plurality of sources, at least one candidate concept related to a term contained in a document; annotating the at least one candidate concept with at least one of a uniform resource identifier or a uniform resource locator to identify information at a linked data source; disambiguating the at least one candidate concept, the disambiguation being on one or more distance values determined between a first context of the term and a second context of the at least one candidate concept; selecting, based on the disambiguating, the at least one candidate concept for the taxonomy, when the one or more distance values indicate a similarity between the selected at least one candidate concept and the term; and the like. Related apparatus, systems, methods, and articles are also described.

### FIELD

The subject matter described herein relates to generating taxonomies.

### BACKGROUND

Automatic taxonomy generation allows the text found in documents to be organized into a hierarchy to enable searching documents, browsing documents, organizing documents, and the like. The taxonomy may comprise a hierarchy of labels identifying concepts and sub-concepts in the documents, which can be used to facilitate searching documents stored within an enterprise as well as documents accessible via the Internet. Moreover, the taxonomy may include concepts related to those concepts directly found in the documents to allow searching, browsing, and the like of these related concepts.

### SUMMARY

In some example embodiments, there may be provided a method. The method may include extracting, from a plurality of sources, at least one candidate concept related to a term contained in a document; annotating the at least one candidate concept with at least one of a uniform resource identifier or a uniform resource locator to identify information at a linked data source; disambiguating the at least one candidate concept, the disambiguation being based on one or more distance values determined between a first context of the term and a second context of the at least one candidate concept; selecting, based on the disambiguating, the at least one candidate concept for the taxonomy, when the one or more distance values indicate a similarity between the selected at least one candidate concept and the term; storing the selected at least one candidate concept with other selected concepts arranged in a taxonomy; consolidating, based on one or more rules, a plurality of concepts arranged in the taxonomy, the plurality of concepts including the selected at least one candidate concept and the other selected concepts; and providing, based on the consolidated plurality of concepts, the taxonomy as an output.

In some variations of some of the embodiments disclosed herein, one or more of the features disclosed herein including one or more of the following may be included. For example, the one or more distance values may represent a semantic relatedness between the first context of the term and the second context of the at least one candidate concept. The semantic relatedness may be determined based on at least one of a Levenshtein Distance, a Dice Coefficient, and a Sorensen Similarity Index. The plurality of sources may comprise at least one of a publically accessibly database, a knowledge base, a taxonomy, a thesaurus, and a Wikipedia. The first context may comprise a first set of labels associated with the term and the second context may comprise a second set of labels associated with the at least one candidate concept. A plurality of concepts may be consolidated after disambiguation in order to form an output taxonomy. The storing may be in accordance with a model, and may include storing the at least one candidate concept and the term. The model may define a mapping among the term and the at least one candidate concept, the model may further define metadata associated with at least one of the term or the at least one candidate concept.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts a block diagram of a process for programmatically generating a taxonomy, in accordance with some example implementations;

FIG. 1B depicts an example of a taxonomy which may be used as an input to the process of FIG. 1A, in accordance with some example implementations;

FIG. 1C depicts an example page including a generated taxonomy, including concepts, preferred labels, and alternative labels, in accordance with some example implementations;

FIG. 2 depicts an example model, in accordance with some example implementations;

FIG. 3 depicts an example disambiguation process, in accordance with some example implementations;

FIG. 4 depicts an example ngram mapped to ambiguous concepts, in accordance with some example implementations;

FIGS. 5A-C depicts examples of pruning used to consolidate concepts, in accordance with some example implementations; and

FIG. 6 depicts an example system for programmatically generating a taxonomy, in accordance with some example implementations.

Like labels are used to refer to same or similar items in the drawings.

### DETAILED DESCRIPTION

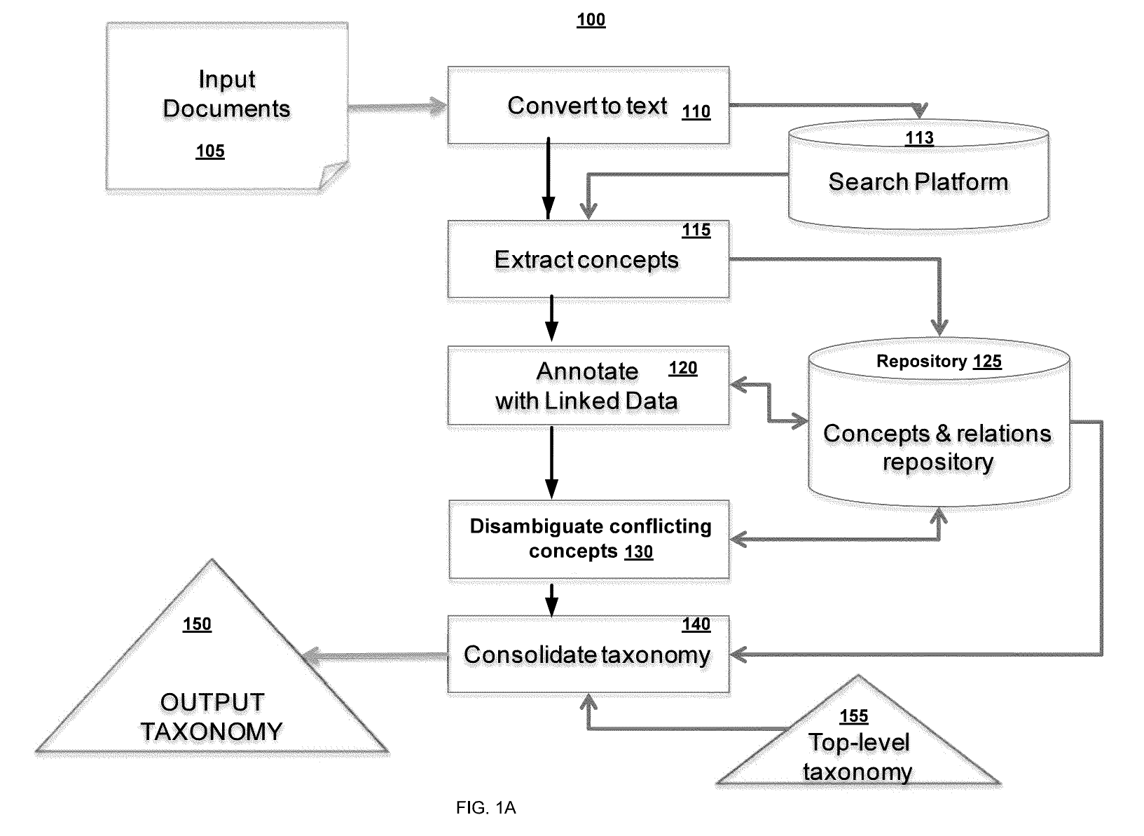

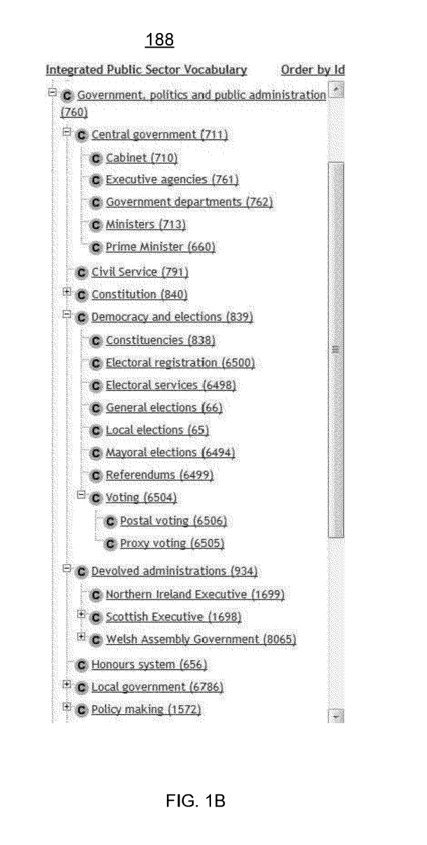

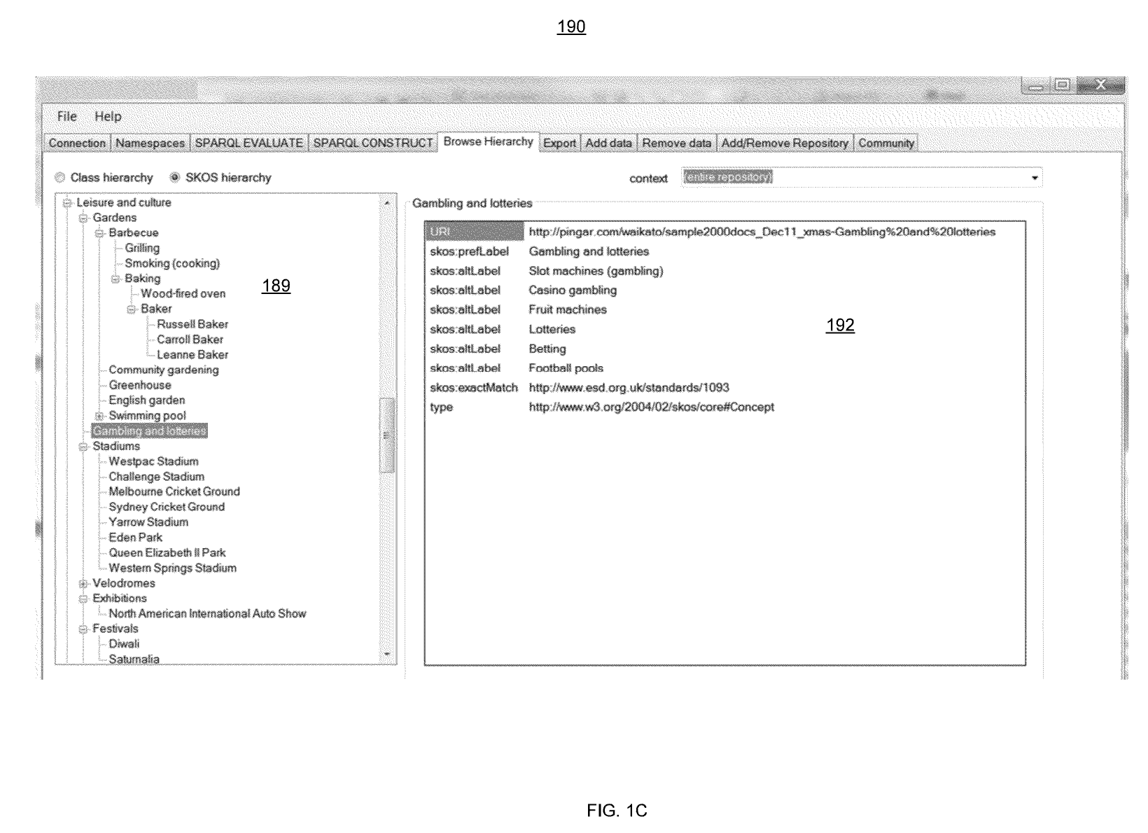

FIG. 1A depicts an example process 100 for taxonomy generation, in accordance with some example implementations. The process 100 may include receiving, or accessing, at 110 one or more documents 105, converting at 110 the documents into a text-based format, extracting at 115 one or more concepts from the converted text and storing those concepts in repository 125, and annotating at 120 the concepts stored at repository 125 with links to data sources (e.g., annotated with uniform resource indicators/locators identifying documents or entries in publicly accessible datasets/databases/knowledge bases the like). The process may also include disambiguating at 130 any conflicting concepts, consolidating at 140 the concepts based on the disambiguation 130 and any taxonomies provided as input (e.g., at 155), and generating at 150 an output taxonomy.

At 110, one or more documents 105 may be may be converted into text. The documents 105 may represent documents within a collection, documents in an enterprise, documents accessed via the Internet/websites, or a combination thereof. Moreover, documents 105 may be stored in one or more formats compatible with certain file systems, servers, databases, and document management systems hosting the documents. As such, a text converter may be used to convert at 110 documents 105 into a text-based format and, in some implementations, a single format, which can be used throughout process 100. In some example implementations, the text converter may include a text extractor (e.g., Apache Tika and the like) to extract text from documents 105 and further access a search platform 113 (e.g., using Apache Solr and the like) to generate, based on the extracted text, an index for documents 105. For example, some of the extracted text may be used in an index of concepts contained in documents 105.

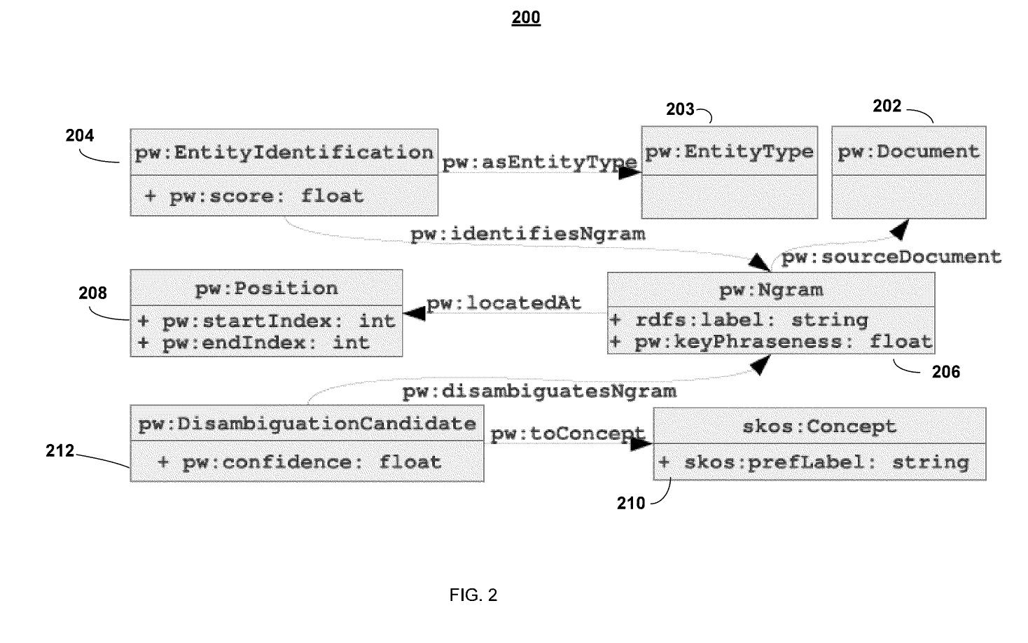

In some example implementations, documents 105 may be referenced by a locator, such as a uniform resource locator (URL) or a uniform resource identifier (URI). The document (and/or locators) may be associated with concepts extracted during process 100, and these concepts may be arranged in a taxonomy 150 containing these concepts. Moreover, these concepts, the locators associated with the documents containing the concepts, and/or associated metadata may be stored in accordance with a model, such as a resource description framework (RDF) described further below with respect to FIG. 2.

At 115, once the documents 105 are converted into text concepts may be extracted at 115 from documents 105. Concepts may be obtained by matching text extracted from documents 105 against knowledge bases, such as Wikipedia, thesauruses, taxonomies, and the like, containing concepts. This matching process may be performed using various tools (e.g., a wikification tool, an automated subject indexing tool, or any text analytics service/application programming interface (API) configured to perform text matching). Concepts may include specific terminology and abbreviations identified in document text using for example a terminology extractor. Some of the concepts may comprise entities. An entity may represent a type of concept, and, in particular, may represent a person, a place, an organization, an event, and any other type of named entity found in document text (identified using, for example, a named entity recognition tool and the like). In some implementations, the extracted concepts/entities may be stored in repository 125. Moreover, the stored information may be in accordance with a model, as described further below with respect to FIG. 2.

In some example implementations, one or more taxonomies from areas related to the input documents may be provided as an input to the process at 115. For example, if the input documents relate to agriculture, then a taxonomy related to agriculture may be provided as an input to the process at 115. The concepts from these related taxonomies may be extracted by a taxonomy term extractor or a subject indexing tool and may be stored in repository 125 alongside other concepts extracted at 115. These taxonomies may be received at 155 or at other points in process 100 as well.

FIG. 1B depicts an example taxonomy which may be received as an input at 115, although other types of taxonomies may be received as well. The taxonomy 188 may be predetermined and provided as an input to augment the taxonomy generation process 100.

FIG. 2 depicts an example of a model based on a resource description framework (RDF) 200, in accordance with some example implementations. In some example implementations, each occurrence of a concept extracted at 110 from document 105 may be stored as an ngram 206 with associated metadata describing that ngram 206. The term “ngram” refers to a contiguous sequence of n items, which in this case are words from a given sequence of text. For example, a document may include a sentence with 11 words, such as the following: “San Francisco has a great public library with “thousands of books.” In this example, the occurrences of three concepts “San Francisco,” (a city) “library” (an institution), and “book” may be treated as ngrams “San Francisco,” “library,” and “books.” Moreover, repository 125 may store these three objects as 3 ngrams “San Francisco,” “library,” and “books.” The RDF 200 may thus provide a standard format for accessing and/or storing one or more ngrams 206 extracted from documents 105, one or more concepts 210 mapped to the ngrams 206, and associated metadata regarding the ngrams, concepts, and the like. Moreover, repository 125 may store data in accordance with RDF 200.

The metadata at RDF 200 may include an identifier (or locator) 202 for a document 105 from which the ngram was extracted, position information 208 for the ngram, mapping(s) 212 to one or more candidate concepts 210 extracted from knowledge bases at 115 (or annotated at 120), entity type information 203 for the ngram, a probability score 204 representative of how likely the ngram is of a particular entity type. For example, ngram “Sydney” can be an entity of types “location” or “person,” and the probability of each entity type differs depending on the context. The metadata at 200 may also include one or more candidate concepts 210 connected to the ngram 206 via a disambiguation candidate relation 212. This relation 212 captures the confidence with which the concept extraction links an ngram to a given concept. The concept itself may be described as a series of labels 210 (or strings), such as its preferred name (prefLabel) and one or more alternative names (altLabel). To illustrate, the ngram “San Francisco” (which corresponds to an entity extracted from the document at 115) may also be identified as an entity having an entity type 203 “Location” and a position 208 with a start index 0 and end index 12 (which is the index of the last character in the string), although other entity types (e.g., person, places, organization, events, and the like) and indexes may be used as well based on a given ngram. The ngram “San Francisco” may be also mapped to candidate concepts 206 “San Francisco” (http://en.wikipedia.org/wiki/San_Francisco) and “Monastery of San Francisco” (http://en.wikipedia.org/wiki/Monastery_of San_Francisco,_Lima). Although the previous example describes Wikipedia as the knowledge base from which the concept is extracted, concepts may be extracted from other sources and databases as well.

Referring again to FIG. 1A, one or more of the concepts extracted at 115 may be annotated, at 120, with unique identifiers for those concepts when found in another knowledge base, such as publicly accessible data sources (also referred to as linked data sources). Examples of linked data sources include Freebase, DBPedia, GeoNames, and the like. The annotation may be performed by querying one or more of linked data sources for additional related concepts that map to the entities extracted at 115. For example, if an ngram is identified at 115 as an entity of type “person,” that entity type may be annotated with a concept linking to the definition of that entity in a linked data source, such as Freebase. Although Freebase does not list a concept for every person that may be featured in news articles, Freebase may list concepts for famous politicians or actors, such as “Barack Obama” or “David Duchovny.” The data behind those concepts (e.g., profession, birth date, semantic relations) may be accessed via a unique identifier, such as a URI (e.g. http://www.freebase.com/view/en/barack_obama).

To illustrate further, the annotation at 120 may include linked data for the concept “San Francisco” and, when a knowledge base such as Freebase or DBpedia is used, the URI(s) may correspond to www.freebase.com/view/en/san_francisco. Annotation at 120 may include the URI(s) (as links to the linked data) in the final taxonomy output at 150 to augment the taxonomy 150. For example, the addition of the URI(s) may augment organization and browsing of documents based on additional data contained in the linked data source, which in the previous example is Freebase (although other knowledge bases may be used as well). The output taxonomy 155 may, in some implementations, be linked to, and described in terms of, knowledge present in linked data sources enabling semantic web applications.

The annotation process may use the entity identification/concept extraction output to find relevant concepts related to the ngram. Specifically, the mapping from an entity to a concept found in linked data (“linked data concept”) may be defined based on entity types translated to linked data concept classes. For example, an entity type 203 defined for “person” (pw:person) may be translated to a concept class, such as http://rdf.freebase.com/ns/people/person. For each extracted person entity, this linked data source may be further queried to find lexically matching concepts. Annotation at 120 may select one or more of these lexically matching candidate concepts for each entity. The quantity of the candidates selected may be predetermined based on a parameter, which may be configured by a user. In any case, these candidate concepts may be disambiguated at 130 along with other candidate concepts.

At 130, disambiguation may be performed to resolve ambiguities in the concepts extracted at 115. The disambiguation may also resolve ambiguities, when linked data concepts are identified at 120. For example, a document 105 may contain the following sentence: “Apple is a fruit that grows in many western countries and is often used for making apple juice.” In this example, disambiguation may determine whether the ngram for the entity “apple” extracted from documents 105 corresponds to the meaning of related concepts extracted at 115, such as “apple” referring to the fruit, “Apple” referring to the company, and the like. To determine whether the concepts truly share the same meaning and thus should be mapped to the same ngram, a disambiguator may perform at 130 disambiguation to determine which of the plurality of concepts are likely to be properly related to a given ngram extracted from documents 105.

To determine if the concepts mapped to the same ngram share the same meaning, disambiguation at 130 may perform a contextual analysis to determine a correct mapping between a given ngram extracted from documents 105 and one or more concepts extracted at 115 (or annotated at 120). This mapping may result in a canonical concept containing references to an exemplary concept.

Disambiguation at 130 may, as noted, identify mappings corresponding to conflicting concepts. These conflicting concepts may be identified by analyzing each document 105 including the ngrams therein to determine ambiguities. If an ngram is mapped to only one concept, this mapping is considered unambiguous. This unambiguous concept from a given ngram 206 may be stored as a concept 210 at repository 125 in accordance with RDF 200 and/or later (at 140) may be added directly to the output taxonomy 150. For example, an unambiguous concept may refer to a concept that only exists in one knowledge base (e.g., a sample taxonomy may include a specific concept like “publicly-owned land,” which may not have any conflicting entries in other knowledge bases, such as Wikipedia, Freebase, or any other source). As such, if concept extraction in 115 identifies a concept in a document having no other mappings to other concepts, no disambiguation is required.

However, a given ngram having mappings to a plurality of concepts may be ambiguous and thus require disambiguation. For example, document 105 may include (or its index may include) an ngram “apple.” The ngram “apple” may be mapped to a concept “apples” in a predetermined taxonomy (which may serve as inputs to process as noted above). The ngram “apple” may also be mapped to a concept “apple” found in Wikipedia at http://en.wikipedia.org/wiki/Apple. In this example, both mappings correspond to the fruit, whereas entity extraction at 115 may also identify “Apple” as a company, which may result in annotation at 120 with another knowledge base http://www.freebase.com/view/en/apple_inc (which also corresponds to a company). In this example, disambiguation at 130 may select which of the plurality of mappings for the ngram “apple” are correct.

When an ambiguity in concepts is detected, disambiguation at 130 may analyze the context of the ngram in a given document 105 and then compare the context to the one or more meanings of candidate concepts.

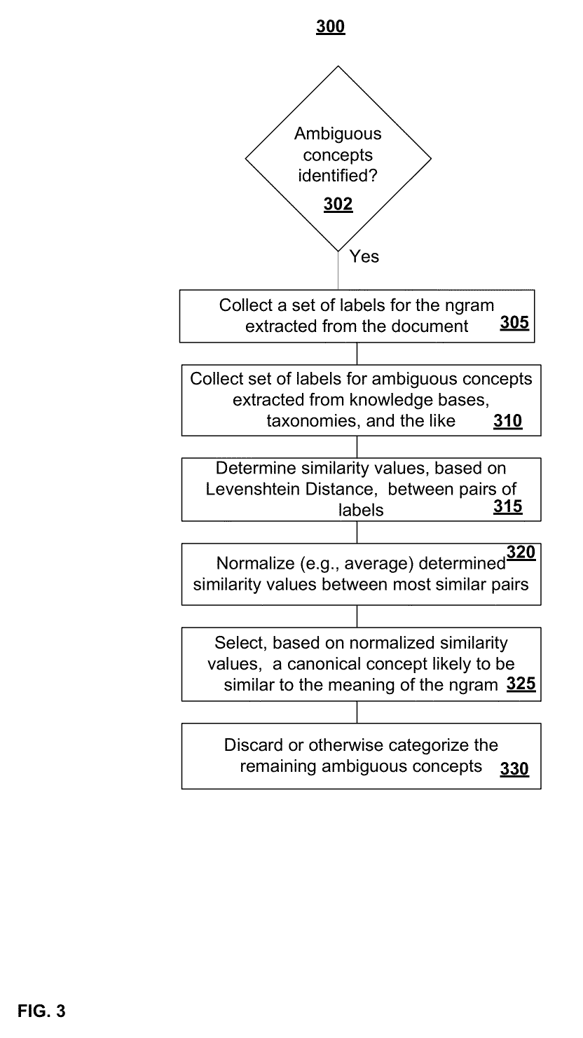

FIG. 3 depicts an example process 300 for disambiguation, in accordance with some example implementations. Conflicting concepts may be identified to determine whether the concepts are ambiguous. For example, a disambiguator may determine one or more concepts that are unambiguous and one or more concepts that are ambiguous. The unambiguous concepts may be added directly in the output taxonomy 155 or stored at repository 125 for consolidation at 140. However, if ambiguous concepts are identified (yes at 302), further processing is performed (305-330) to determine whether to add the concepts to the output taxonomy 155.

In some implementations, the labels for the candidate concepts may be obtained from its broader concepts (e.g., skos:broader), its narrower concepts (e.g., skos:narrower), and/or its related concepts (e.g., skos:related). The candidate concept is then characterized by the set of labels of these concepts. Moreover, a candidate concept may be characterized by its preferred label (e.g., skos:prefLabel) and its alternate labels (e.g., skos:altLabel). For example, a candidate concept “apples” may be listed in an input taxonomy (e.g., Agrovoc) and may list a preferred label for the ngram “apple,” and the candidate concept “apples” may have a broader related candidate concept (e.g., skos:broader) “pomi fruits,” related concepts “apple juice” and “malus” (e.g., relatedskos:related), and an alternative concept “crab apples” (skos:altLabel), and these characterizations may be stored in repository 125 in accordance with the RDF 200.

At 305, a set of labels are collected for the ngram extracted from the document. For example, the context of the ngram may be expressed as a set of labels representing concepts co-occurring in the document. The ngram and the set of labels may form the context of the ngram in the document and thus provide an indication of the meaning of the ngram. For example, the ngram “apple” may be extracted from document 105, while the set of labels may corresponds to co-occurring labels “apple juice” and “pomiculture,” which are also contained in the document 105.

At 310, a set of labels are also collected for ambiguous concepts extracted at 115 from knowledge bases (and/or annotated at 120). For example, concept extraction at 115 may identify from for example a wikipedia article the concept “apple” the fruit and another wikipedia article may identify the concept “Apple” the company. As such, a set of labels may be extracted for each of the ambiguous, candidate concepts. For example, the Wikipedia article apples expressing the concept of “apple” the fruit may have redirect pages in Wikipedia with names such as “malus domestica” and “pomiculture.” These names can be collected as context labels, in addition to labels of other Wikipedia articles mentioned in the Wikipedia article apples, or in specific parts of that article. Consequently, this set of labels may be associated with the concept apple the fruit. On the other hand, the concept “Apple” the company may be listed in a taxonomy. As such, the set of labels may be collected by adding preferred labels of its related concepts, such as “Steve Jobs” and “ipad,” so this set of labels may be associated with Apple the company.

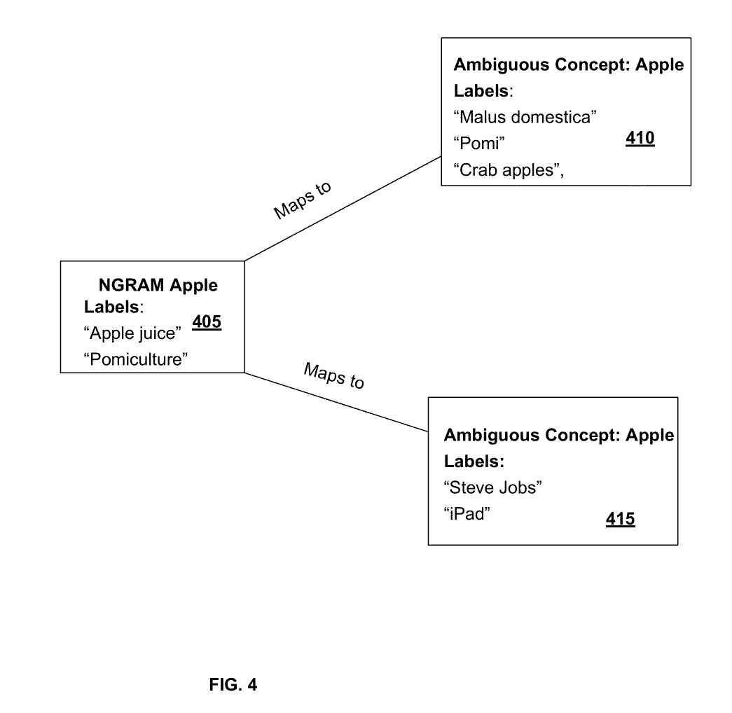

FIG. 4 depicts the ngram “apple” 405 mapped to the concept apple 410 the fruit and Apple 415 the company. FIG. 4 depicts how sets of labels have been associated with each of the concepts. These labels are computed each time a new ngram is analyzed in a given document and each time a new concept is compared as a potential candidate. In order to speed up the processing, the labels for all previously processed ngrams and concepts may be stored in a virtual memory, a cache, and/or an in-memory database and then retrieved if the same ngrams or concepts are being analyzed.

Referring again to FIG. 3, a distance measure may be determined at 315 to assess the similarity or relatedness between the sets of labels. For example, the semantic relatedness between the ngram and each of the ambiguous/candidate concepts may be determined by comparing the sets of labels associated with the ngram to the sets of labels associated with candidate concepts. In some implementations, the sets of labels associated with the ngram are compared to each of the sets of labels associated with each of the candidate concepts based on a Levenshtein Distance (LD), although other metrics may be used as well. Examples of other relatedness metrics include the Dice Coefficient, the Sorensen Similarity Index, the Jaccard Index, Hamming, Jaro-Winkler distance, or any other edit distance metric. For example, the Dice Coefficient and/or Sorensen Similarity Index may be calculated to compare sets of character pairs and thereby assess similarity/relatedness.

In implementations utilizing the Levenshtein Distance (LD), it measures the lexical variation of pairs of labels. Specifically, the Levenshtein Distance between two labels may be determined as the minimum number of edits needed to transform one label, such as “apple” into the other label “apples,” with the allowable edit operations being insertion, deletion, or substitution of a single character. For example, the Levenshtein Distance may be calculated between each of labels for the ngram and each one of the labels for the candidate concepts to determine whether the ngram and the candidate concepts are likely to be similar. Referring again to FIG. 4, the Levenshtein Distance may be calculated between the ngram label “apple juice” and each one of the candidate concept labels at 410. For example, the Levenshtein Distance may be determined pair-wise between apple juice and malus domestica, apple juice and pomi, and apple juice and crab apples, and then pair-wise between pomiculture and malus domestica, pomiculture and pomi, and pomiculture and crab apples. Next, the Levenshtein Distance may be calculated between “apple juice” and each of the labels at 420, and then between “pomiculture” and each of the labels at 420. The calculated Levenshtein Distances may thus provide an indication of the semantic relatedness of the ngram 405 to each of the concepts 410 and 415.

Referring again to FIG. 3, the Levenshtein Distances may be normalized (or averaged), at 320, to allow comparison. For example, a final similarity score may be computed by averaging the Levenshtein Distance over the top N most similar pairs of Levenshtein Distances values. The value of N may be chosen as the size of the smaller set of labels because if the concepts in the two sets of labels are truly identical, then every label in the smaller set of labels should be able to find at least one reasonably similar partner in the larger set of labels.

At 325, a canonical concept may be selected based on the normalized/averaged Levenshtein Distances. For example, the Levenshtein Distances may be determined pair-wise from the set of labels of the ngram and each of the set of labels of the candidate concepts. Moreover, a canonical concept from among the candidate concepts may be selected based on the calculated Levenshtein Distances and, in some implementations, the normalized Levenshtein Distances. Returning to the example depicted at FIG. 4, ngram's 405 set of labels, “apple juice” and “pomiculture,” correspond to the content of the document. The second set of labels, “malus domestica,” “pomi,” and “crab apples,” correspond to a candidate concept apple the fruit. The third set of labels, “Steve Jobs” and “ipad,” correspond to the company Apple. In this example, the first set of labels (“apple juice” and “pomiculture”) contain the smallest number of concepts, that is 2, so the value of N is 2. Moreover, the top scoring (e.g., most similar) pairs for the first set of labels and the second set of labels is apple juice and crab apples (having a LD equal to about 0.5) and pomiculture and pomi (having a LD equal to about 0.308). The average of 0.404 represents the overall similarity of the first and second sets of labels. The top scoring pair for the first set of labels versus the third set of labels is pomiculture and ipad (having an LD equal to about 0.154). All other pairs in this set have an LD of about 0.0, so the average over the top 2 pairs is 0.077. This means that in the given document apple (the fruit) 410 may be selected based on the average of 0.404 as the canonical concept for the ngram apple extracted from the document 105. Although the previous example provides specific values, these are only exemplary as other values may be determined using the LD as well as other relatedness metrics, distance metrics, and/or similarity metrics.

Referring again to FIG. 3, the similarity score may also be used to determine whether to discard at 330 a candidate concept, determine whether a candidate concept is an exact match, or whether a candidate concept is a close match. For example, a threshold value may be used in conjunction with similarity scores to determine whether a concept is an exact match to the ngram, a close match to the ngram, or discarded as dissimilar to the ngram. In some implementations, the threshold may be configured as a plurality of thresholds as shown in Table 1 below. Table 1 below depicts examples of similarity scores and thresholds for which a candidate concept would be discarded, considered a close match to the canonical concept for the ngram in the document 105, or an exact match to the canonical concept.

TABLE 1

| similarity score (s) | action |
|---|---|
| s ≦ 0.7 | discard concept |
| 0.7 < s ≦ 0.9 | list as skos:closeMatch |
| s > 0.9 | list as skos:exactMatch |

The thresholds at Table 1 may also be used to assess similarity among conflicting candidate concepts extracted at 115 and/or annotated at 120 and the canonical concept selected at 325. Referring to the previous apple example, after choosing apple the fruit as a canonical concept, a calculation may determine whether Apple the company can be considered a close match, an exact match, or discarded. The similarity between the canonical concept and the other concepts (Apple the company) may be averaged over the top scoring pairs “malus domestica/Steve Jobs” (having an LD equal to 0.105), “pomi/ipad” (having an LD equal to 0.333), and a third pair “Crab apple/ipad” having an LD equal to about 0.01. Based on Table 1, the other candidate concept 420 may be discarded at 330 since these values are below the 0.7 threshold at Table 1, so that only the canonical concept 410 is kept for further processing (e.g., added to the output taxonomy 155 or stored at repository 155 for consolidation at 140).

To further illustrate disambiguation, the ngram “oceans” (extracted from a document at 105) may match three related concepts extracted at 115: “ocean” and “oceanography” (both obtained from Wikipedia articles) as well as “Marine areas” (a term obtained from a taxonomy). The concept “ocean” may be selected as the canonical concept, and this canonical concept “ocean” may then be compared as noted above to the other candidate concepts. This comparison may result in the canonical concept “ocean” having the greatest similarity score with respect to the ngram “oceans.” The similarity score of 0.869 between the canonical concept “ocean” and the concept “Marine areas” may have a value corresponding to a close match (e.g., skos:closeMatch). In this example however, the concept “oceanography” may be designated for discard based on its similarity score, which is below 0.7.

Although Table 1 depicts specific thresholds, these thresholds are only exemplary as other threshold values may be used as well to determine whether concepts are a close match, an exact match, or whether a concept should be discarded.

FIG. 1C depicts an example page 190 including taxonomy 189 including concepts and preferred and alternative labels defined for the concept “Gambling and Lotteries.” This concept has an exact match, skos:exactMatch URI (e.g., http://www.esd.org.uk/standards/103), linking to a concept in an input taxonomy, which has an equivalent meaning as the meaning determined during the disambiguation process 130. Both the preferred and the alternative labels at FIG. 1C may be copied to the output taxonomy 150, so that the concept “Gambling and Lotteries” in the taxonomy includes the preferred and alternative labels in the output taxonomy 150.

Referring again to FIG. 1A, concepts provided by 130 may be consolidated at 140 in order to form output taxonomy 150. For example, a consolidator may at 140 access the concepts at repository 125 and consolidate one or more concepts by adding, deleting, and modifying concepts to form the output taxonomy 150. The consolidation may also take into account other taxonomies, such as taxonomy 155. The consolidation may include detecting direct relations among concepts, adding relations among concepts, and/or deleting relations among concepts as described further below. In any case, the consolidated results may be included in output taxonomy 150. The output taxonomy may be used for semantic searching of documents, browsing documents, organizing documents, and the like.

To consolidate concepts at 140, the consolidator may detect include a rule to detect direct relations between concepts at repository 155 being considered for output taxonomy 155. For each of these concepts at repository 155, broader or narrower concepts may be retrieved from other taxonomies or knowledge bases. If these broader and narrower concepts match the input concepts (i.e., concepts at repository 155 being considered for output taxonomy 155), the corresponding relations from the broader and narrower concepts may be added to the taxonomy output 150. For example, the concept “Students” may have a narrower concept “Pupil” which may be added at 140 to the output taxonomy 155. If a concept has a Wikipedia URI, the corresponding relations may be added to the output taxonomy 155 if the names of the immediate Wikipedia categories match other concepts.

To consolidate concepts at 140, the consolidator may include a rule to iteratively add relations via additional concepts based on the generalization that some concepts that do not appear in documents might be useful for grouping input concepts. For each concept with a taxonomy URI, the consolidator may use a transitive semantic query (e.g., SPARQL query) to check whether two concepts can be connected via one or more other concepts. For example, two concepts “apple” and “pear” may be connected via a concept “fruit,” which may be added to the taxonomy in order to group these concepts. The number of transitive steps can be increased depending on the nature of the taxonomy. If a relation is found by the query, the intermediate concept may be added to the taxonomy to connect the original two concepts, and the corresponding relations may be populated. The consolidator may then check whether the new concept may be connected to any other concepts using immediate relations. As such, related concepts, such as Music and Punk rock, may be connected via an additional concept music genre, whereupon a further relation is added between Music genres and Punk.

To consolidate concepts at 140, the consolidator may also include a rule to add relations via useful Wikipedia categories. When adding new concepts from Wikipedia, the consolidator may avoid using so-called “uninteresting categories.” The degree of interest is defined within the document collection itself 105. For example, categories that combine concepts that tend to co-occur in the same documents may be relevant in order to generate the output taxonomy 150. This technique may help eliminate categories that combine too many concepts (e.g., Living people, in a news article) or that do not relate to others (e.g., American vegetarians that group American celebrities that typically do not co-occur in documents). Instead, useful categories may be added to the taxonomy as new concepts, such as Seven Summits connecting Mont Blanc, Puncak Jaya, Aconcagua, and Mount Everest.

To consolidate concepts at 140, the consolidator may also include a rule to detect further relations within a knowledge base structure, such as a Wikipedia category structure. For example, the consolidator may retrieve broader categories for newly added categories and check whether their names match existing concepts in the taxonomy.

To consolidate concepts at 140, the consolidator may also include a rule to seek relations within article and category names. For example, the consolidator may determine whether parenthetical expressions in Wikipedia article names (e.g., http://en.wikipedia.org/wiki/Madonna (entertainer)) match the labels of other concepts at repository 155 that are being considered for output taxonomy 155. Decomposing category names into noun phrases can also lead to new relations among concepts. The consolidator may also check whether the category name's head noun or even its last word matches any other concepts at repository 155 that are being considered for output taxonomy 155. The consolidator may then choose only the most frequent concepts to reduce errors, which may be introduced.

To consolidate concepts at 140, the consolidator may also include a rule to add relations to top-level concepts. The consolidator may retrieve for each concept at repository 155 (being considered for output taxonomy 155) its broadest related concept. For example, the consolidator may add relations like cooperation and its broadest business and industry. Other mechanisms may be used as well to consolidate concepts based on source or geographical location.

Next, consolidation of concepts at 140, after all, or some, possible concepts have been connected using various heuristics (also referred to as rules) outlined above, pruning may also be used in order to eliminate less-informative parts of the tree. For example, pruning may comprise compressing single-child parents or dealing with multiple inheritance. If a concept being considered for output taxonomy 155 has a single child that in turn has one or more further children, the consolidator may remove the single child and point its children directly to its parent. For multiple inheritances, either a relation or a previously added concept may be removed by examining the taxonomy tree. A relation may be pruned when a similar relation is defined somewhere else in the same sub-tree, if it does not add any new information.

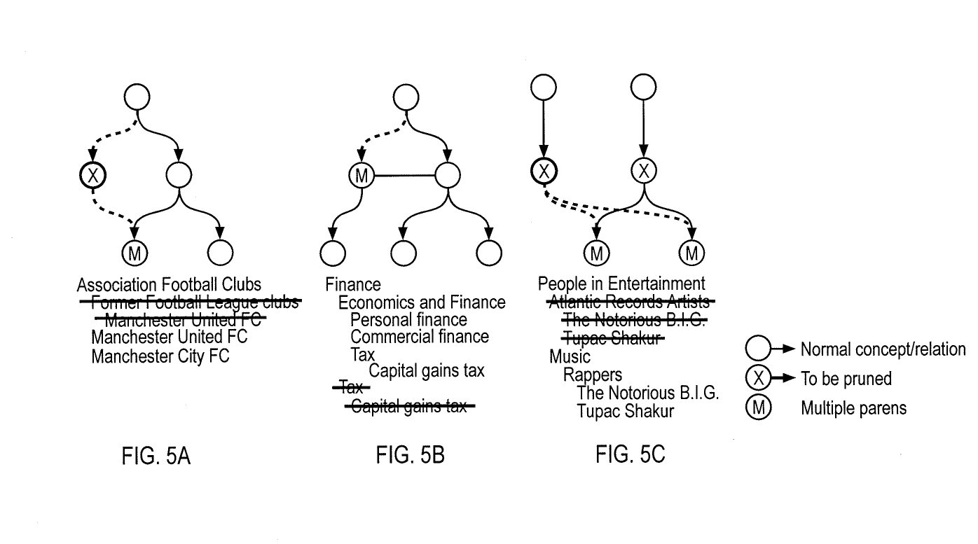

FIGS. 5A-C shows examples of where parts of three trees may be considered less informative and may be pruned during consolidation at 140. In FIG. 5A, Manchester United F.C. has two parents, where one of them is the other's child. Whereas multiple inheritance is usually useful in taxonomy (it allows finding a concept through its different characteristics), if it happens within the same small sub-tree of a taxonomy, it is not helpful for the user. In order to unite the various subtrees, a predefined top-level taxonomy may be used, in which case the top-level taxonomy may be merged with any input taxonomy 155 before consolidation commences. Words may also be added to place an input concept under a given top-level concept, and the added words may be used when analyzing the labels of input concepts or their Wikipedia category names. As such, pruning may enable multiple-inheritance in taxonomy and detecting differences between useful and not so useful (less-informative) cases of multiple inheritances.

Referring again to FIG. 1A, concepts provided by 130 have been consolidated at 140, and then provided as an output taxonomy 150. The output taxonomy 155 may be used for browsing, storing, searching, and/or organizing documents stored in a database, a website, or in any other document collection.

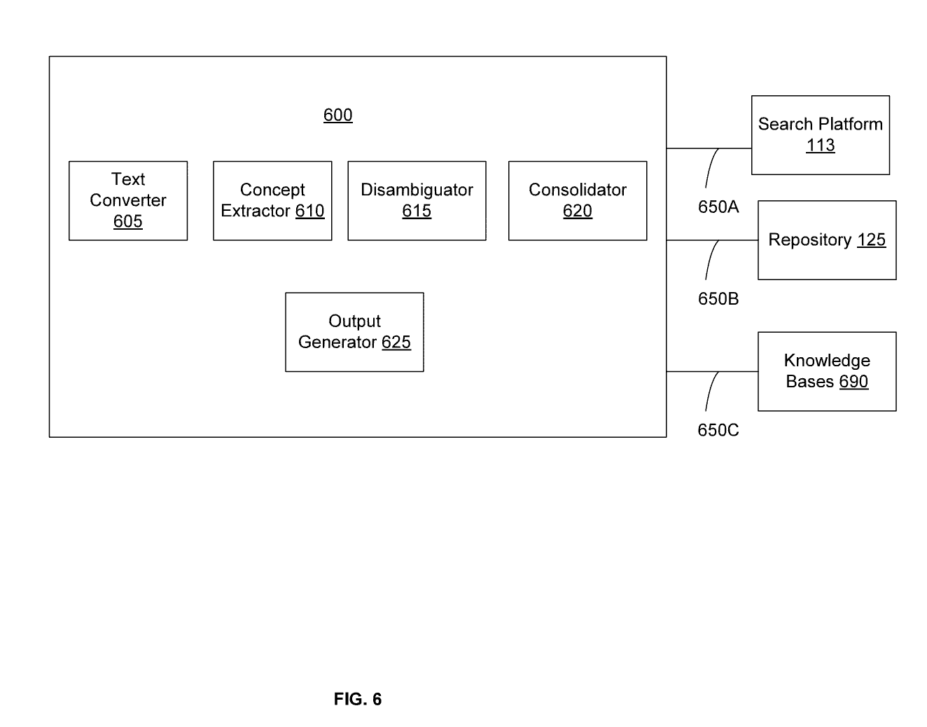

FIG. 6 depicts an example of a system 600, in accordance with some example implementations. The system 600 may include a text converter 605 for converting text in documents 105, a concept extractor 610 for extracting concepts, a disambiguator 615, a consolidator 620, and an output generator 625 for providing the output taxonomy 155. The system 600 may also couple via communication mechanisms (e.g., the Internet, an intranet, and/or any other form of communications) 650A-C to search platform 113, repository 125, and one or more knowledge bases, such as knowledge base 690.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims. As used herein, the phrase “based on” includes “based on at least.” As herein, the term “set” may include zero or more items.

What is claimed:

1. A method for generating a taxonomy, the method comprising:
extracting, from a plurality of sources, at least one candidate concept related to a term contained in a document;
annotating the at least one candidate concept with at least one of a uniform resource identifier or a uniform resource locator to identify information at a linked data source;
disambiguating the at least one candidate concept, the disambiguation being on one or more distance values determined between a first context of the term and a second context of the at least one candidate concept;
selecting, based on the disambiguating, the at least one candidate concept for the taxonomy, when the one or more distance values indicate a similarity between the selected at least one candidate concept and the term;
storing the selected at least one candidate concept with other selected concepts arranged in a taxonomy;
consolidating, based on one or more rules, a plurality of concepts arranged in the taxonomy, the plurality of concepts including the selected at least one candidate concept and the other selected concepts; and
providing, based on the consolidated plurality of concepts, the taxonomy as an output.

2. The method of claim 1, wherein the one or more distance values represent a semantic relatedness between the first context of the term and the second context of the at least one candidate concept.

3. The method of claim 2, wherein the semantic relatedness are determined based on at least one of a Levenshtein Distance, a Dice Coefficient, and a Sorensen Similarity Index.

4. The method of claim 1, wherein the plurality of sources comprise at least one of a publically accessibly database, a knowledge base, a taxonomy, a thesaurus, and a Wikipedia.

5. The method of claim 1, wherein the first context comprises a first set of labels associated with the term and the second context comprises a second set of labels associated with the at least one candidate concept.

6. The method of claim 1, wherein the consolidating is performed after disambiguation.

7. The method of claim 1, wherein the storing further comprises:
storing, in accordance with a model, the at least one candidate concept and the term.

8. The method of claim 7, wherein the model defines a mapping among the term and the at least one candidate concept.

9. The method of claim 8, wherein the model further defines metadata associated with at least one of the term or the at least one candidate concept.

10. A computer-readable medium including code which when executed by at least one processor causes operations comprising:
extracting, from a plurality of sources, at least one candidate concept related to a term contained in a document;
annotating the at least one candidate concept with at least one of a uniform resource identifier or a uniform resource locator to identify information at a linked data source;
disambiguating the at least one candidate concept, the disambiguation being on one or more distance values determined between a first context of the term and a second context of the at least one candidate concept;
selecting, based on the disambiguating, the at least one candidate concept for the taxonomy, when the one or more distance values indicate a similarity between the selected at least one candidate concept and the term;
storing the selected at least one candidate concept with other selected concepts arranged in a taxonomy;
consolidating, based on one or more rules, a plurality of concepts arranged in the taxonomy, the plurality of concepts including the selected at least one candidate concept and the other selected concepts; and
providing, based on the consolidated plurality of concepts, the taxonomy as an output.

11. The computer-readable medium of claim 10, wherein the one or more distance values represent a semantic relatedness between the first context of the term and the second context of the at least one candidate concept.

12. The computer-readable medium of claim 11, wherein the semantic relatedness are determined based on at least one of a Levenshtein Distance, a Dice Coefficient, and a Sorensen Similarity Index.

13. The computer-readable medium of claim 10, wherein the plurality of sources comprise at least one of a publically accessibly database, a knowledge base, a taxonomy, a thesaurus, and a Wikipedia.

14. The computer-readable medium of claim 10, wherein the first context comprises a first set of labels associated with the term and the second context comprises a second set of labels associated with the at least one candidate concept.

15. The computer-readable medium of claim 10, wherein the consolidating is performed after disambiguation.

16. The computer-readable medium of claim 10, wherein the storing further comprises:
storing, in accordance with a model, the at least one candidate concept and the term.

17. The computer-readable medium of claim 16, wherein the model defines a mapping among the term and the at least one candidate concept.

18. The computer-readable medium of claim 17, wherein the model further defines metadata associated with at least one of the term or the at least one candidate concept.

19. A system comprising:
at least one processor; and
at least one memory including code which when executed by the at least one processor causes the system to provide operations comprising;
extracting, from a plurality of sources, at least one candidate concept related to a term contained in a document;
annotating the at least one candidate concept with at least one of a uniform resource identifier or a uniform resource locator to identify information at a linked data source;
disambiguating the at least one candidate concept, the disambiguation being on one or more distance values determined between a first context of the term and a second context of the at least one candidate concept;
selecting, based on the disambiguating, the at least one candidate concept for the taxonomy, when the one or more distance values indicate a similarity between the selected at least one candidate concept and the term;
storing the selected at least one candidate concept with other selected concepts arranged in a taxonomy;
consolidating, based on one or more rules, a plurality of concepts arranged in the taxonomy, the plurality of concepts including the selected at least one candidate concept and the other selected concepts; and
providing, based on the consolidated plurality of concepts, the taxonomy as an output.

20. The system of claim 19, wherein the one or more distance values represent a semantic relatedness between the first context of the term and the second context of the at least one candidate concept.
